(19) United States
(12) Patent Application Publication
(10) Pub. No.: US 2006/0156002 A1
(43) Pub. Date: Jul. 13, 2006

(54) Watermark detection

(75) Inventors: Alphons Antonius Maria Lambertus Bruekers, Eindhoven (NL); Jaap Andre Haitsma, Eindhoven (NL); Minne Van Der Veen, Eindhoven (NL); Antonius Andrianus Cornelis Maria Kalker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., NL-5621 BA Eindhoven (NL)

(21) Appl. No.: 10/521,660

(22) PCT Filed: Jul. 7, 2003
(86) PCT No.: PCT/IB03/03095

§ 371 Date: Jan. 18, 2005

(30) Foreign Application Priority Data
Jul. 22, 2002 (EP) 02077982.3

(51) Int. Cl. H04L 9/00

(52) U.S. Cl. 713/176

(57) ABSTRACT

A watermark detection method is disclosed which is based on computing the cross-correlation between a suspect signal and a watermark. In order to be more robust against prolonged dominant signal components that adversely affect the correlation, the sequence of signal samples (61) to be correlated with the watermark is divided into sub-sequences (A(k)). The sub-sequences are processed, by a weighting function, to obtain modified sub-sequences (B(k)) that individually exhibit the original signal variations, but collectively (62) exhibit a flatter distribution of sample values. Dominant peaks in the signal are thereby substantially reduced.

### FIELD OF THE INVENTION

The invention relates to a method and arrangement for detecting a watermark in a signal, the method comprising the steps of computing a correlation between a sequence of signal samples and a predetermined watermark, and detecting whether said correlation exceeds a given threshold.

### BACKGROUND OF THE INVENTION

Watermarks are imperceptible messages embedded in the content of information signals such as audio or video. Watermarks support a variety of applications such as monitoring and copy control. A watermark is generally embedded in a signal by modifying samples of the signal according to respective samples of the watermark. The term “samples” refers to signal values in the domain in which the watermark is embedded.

A prior art watermark embedding and detection system for audio is disclosed in Jaap Haitsma, Michiel van der Veen, Ton Kalker and Fons Bruekers: “Audio Watermarking for Monitoring and Copy Protection”, ACM Multimedia Conference, Oct. 30-Nov. 4, 2002, pp. 119-122. The audio signal is segmented into frames and transformed to the frequency domain. A watermark sequence is embedded in the magnitudes of the Fourier coefficients of each frame. The detector receives the time-domain version of the watermarked audio signal. The received signal is segmented into frames and transformed to the frequency domain. The magnitudes of the Fourier coefficients are cross-correlated with the watermark sequence. If the correlation exceeds a given threshold, the watermark is said to be present. The expression “sequence of signal samples” defined in the opening paragraph refers to the magnitudes of the Fourier coefficients of an audio frame in this case.

A prior-art watermark embedding and detection system for video is disclosed in Ton Kalker, Geert Depovere, Jaap Haitsma and Maurice Maes: “A Video watermarking System for Broadcast Monitoring”, Proceedings of SPIE, Vol. 3657, January 1999, pp. 103-112. In this system, the watermark is embedded in the pixel domain. The watermark sequence is a 128×128 watermark pattern, which is tiled over an image. The watermark detector correlates 128×128 image blocks with the watermark pattern. If the correlation is sufficiently large, the watermark is said to be present. The expression “sequence of signal samples” defined in the opening paragraph refers to image blocks of 128×128 pixels in this case.

Watermark detection algorithms can be sensitive to attacks or specific signal conditions, such as a strong single tone present in or added to an audio signal, or a strong logo present on a fixed position in every video frame or white subtitle letters at the bottom of every frame.

### OBJECT AND SUMMARY OF THE INVENTION

It is an object of the invention to improve the performance of the prior-art watermark detection method.

To this end, the method according to the invention is characterized in that the method includes pre-processing of said sequence of signal samples, said pre-processing comprising the steps of:
dividing the sequence of signal samples into sub-sequences;
subjecting all signal samples of a sub-sequence to the same weighting, and varying said weighting from sub-sequence to sub-sequence to obtain a substantially flat distribution of signal samples over the sequence; and
concatenating the weighted sub-sequences to obtain the pre-processed sequence of signal samples.

The method according to the invention effectively suppresses large signal peaks while maintaining the small signal variations representing the watermark. This is achieved without knowing or detecting the location of the disturbing component in the signal.

The invention is particularly effective if the watermark detection method includes accumulation of plural signal sequences. Such an accumulation normally improves the detection reliability (the watermark sequences add up whereas the signal is averaged), but this is no longer the case if the signal includes the same disturbing component in substantially all accumulated sequences. In a preferred embodiment of the method according to the invention, the pre-processing is applied to said accumulated sequences. It is thereby achieved that the disturbing component is effectively removed from the accumulated sequences.

In an advantageous embodiment of the method according to the invention, the sequence of signal samples is divided into overlapping, preferably windowed, sub-sequences. A suitable window is the well-known Hanning window, or the square root of the Hanning window. An overlap of 50% has been found to give good results. The concatenated sequence to be correlated with the watermark is obtained by adding the weighted sub-sequences.

Advantageously, the step of weighting comprises Fourier transforming the sub-sequence of signal samples, normalizing the magnitudes of the Fourier coefficients, and back-transforming the normalized coefficients. Alternatively, the step of weighting comprises dividing all signal samples of a sub-sequence by the largest signal sample of said sub-sequence. The second option, i.e. scaling, has a lower arithmetic complexity than the first option where weighting is obtained by normalizing the magnitudes in the frequency domain. In both embodiments, the sequence is adaptively weighted, based on properties of the signal.

### BRIEF DESCRIPTION OF THE DRAWINGS

These and other aspects of the invention are apparent from and will be elucidated with reference to the accompanying drawings, in which:

FIG. 1 shows schematically a prior-art arrangement for embedding a watermark to provide background information about the watermark embedding process.

FIG. 2 shows schematically a preferred embodiment of an arrangement for detecting the watermark in accordance with the invention.

FIG. 3 shows graphs of correlation peak values for an audio signal to illustrate the performance of the method according to the invention.

FIGS. 4-6 show diagrams to illustrate the operation of the watermark detection arrangement which is shown in FIG. 2.

FIG. 7 shows a further graph of correlation peak values to illustrate the performance of the watermark detection method according to the invention.

### DESCRIPTION OF EMBODIMENTS

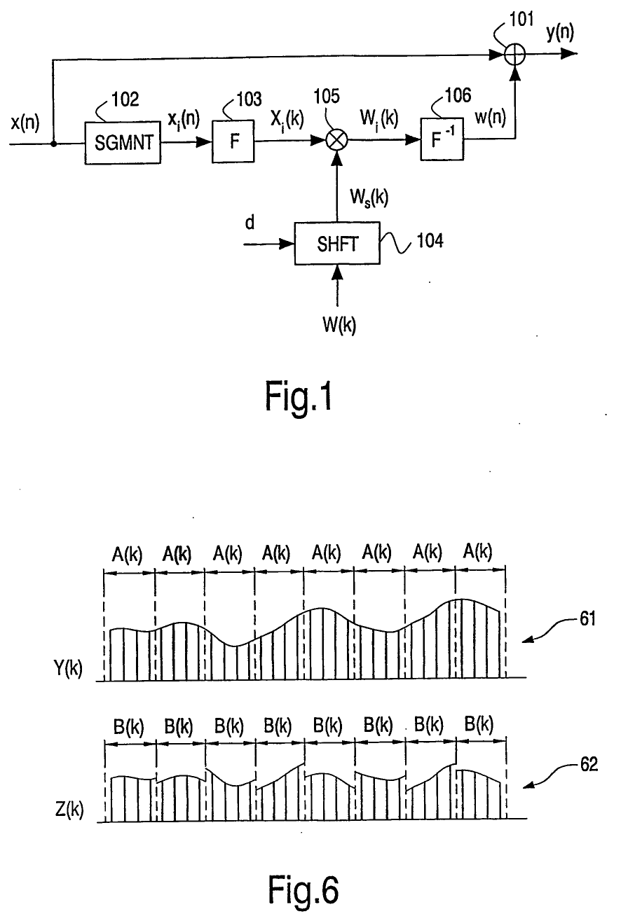

The invention will now be described with reference to the detection of a watermark embedded in an audio signal. An embedding arrangement will first be described to provide background information. FIG. 1 shows schematically such an arrangement. The arrangement receives an audio signal in the form of audio samples x(n), and comprises an adder 101 for adding a watermark w(n) to the signal. The dominant part of the watermark w(n) is derived in the Fourier domain. The arrangement comprises a segmentation unit 102, which segments the audio signal into frames or sequences of 2048 samples. The sequences are transformed using a Fourier transform 103. A random watermark W(k) in the frequency domain is drawn from a normal distribution with mean and standard deviation 0 and 1, respectively. The watermark W(k) is cyclically shifted by an amount representing a 10-bit payload d in a shifting circuit 104. The magnitudes of the Fourier coefficients are modified, by a multiplier 105, in accordance with:
Wᵢ(k)=Wₛ(k)Xᵢ(k)
where i indicates the frame or sequence number, Xᵢ(k) the spectral representation of a frame xᵢ(n), Wₛ(k) the cyclically shifted version of W(k), and Wᵢ(k) the resulting frequency domain watermark. An inverse Fourier transform 106 is used to obtain the time domain watermark representation w(n).

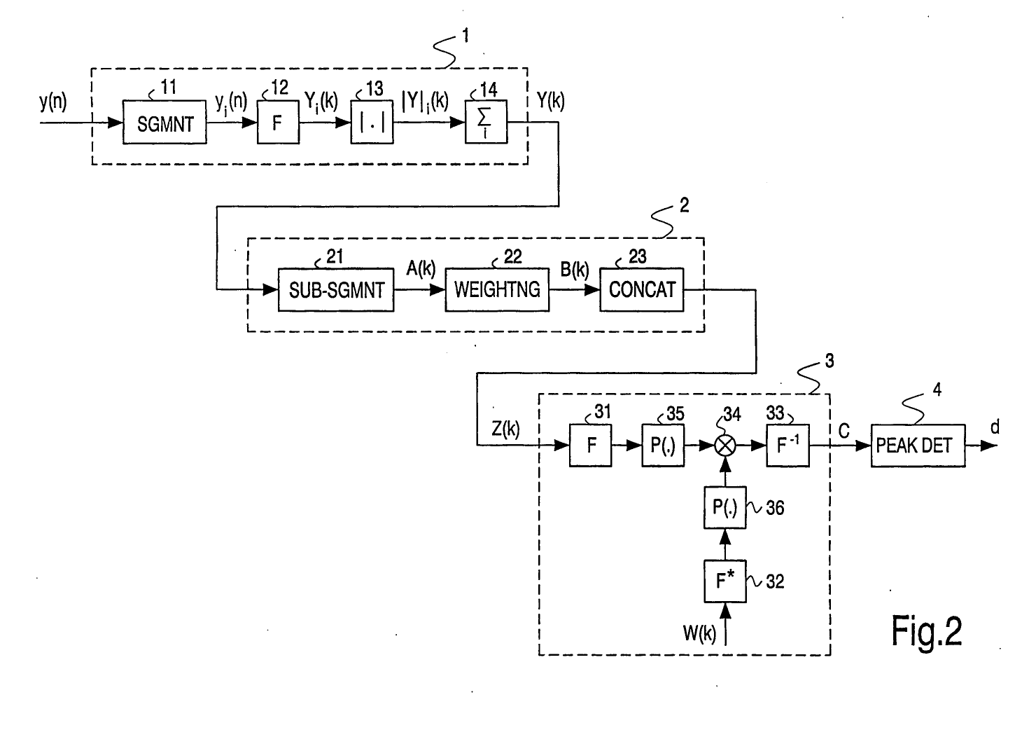

FIG. 2 shows schematically a preferred embodiment of an arrangement for detecting the watermark in accordance with the invention. As has been attempted to illustrate in this Figure, the arrangement comprises three main stages: accumulation (1), pre-processing (2), and correlation (3).

In a segmentation unit 11 of the accumulation stage, the arrangement segments the suspect audio signal y(n) into frames or sequences yᵢ(n) of 2048 audio samples. Each sequence is Fourier transformed (12) and the magnitudes of the Fourier coefficients Yᵢ(k) are computed (13). The magnitudes of Fourier coefficients of frame i constitute a sequence |Y|ᵢ(k) of 1024 real numbers in which the watermark information has been embedded. In the preferred embodiment of the arrangement, a plurality of such sequences |Y|ᵢ(k) is accumulated, by an accumulator 14, to obtain an accumulated sequence Y(k). The number of sequences being accumulated is chosen to represent a period of say, 2 seconds of the audio signal.

The correlation stage 3 will now briefly be described. For a detailed description of watermark detection using correlation, reference is made to International Patent Application WO 99/45707. The correlation stage calculates a correlation C between an accumulated sequence of signal samples (note that “signal samples” in this example refers to magnitudes of Fourier coefficients) and every possible shifted version of the watermark sequence W(k). The correlation stage receives a sequence Z(k). It will initially be assumed that the correlation stage receives the accumulated sequence directly from the accumulation stage 1, i.e. Z(k)=Y(k).

The cross-correlation for every possible shifted version of W(k) is calculated most efficiently using the Fourier transform. The traditional cross-correlation may be written as:
C=F⁻¹(F(Z(k))×F*(W(k)))
where F(.) denotes the Fourier transform, F*(.) the Fourier transform including conjugation of the complex Fourier coefficients, and F⁻¹(.) the inverse Fourier transform. The respective transforms are carried out by Fourier transform circuits 31, 32 and 33 in FIG. 2. The multiplication is performed by a multiplier 34.

The detection performance is enhanced by Symmetrical Phase Only Filtering (SPOMF). In this cross-correlation procedure, only phase information of the signals F(Z(k)) and F*(W(k)) is used. The phase-only operation is defined as:

$$P ( x ) = \frac{x}{\vert x \vert} for x \neq 0 , and P ( 0 ) = 1.$$

and is carried out by respective phase extraction circuits 35 and 36 in FIG. 2,

A peak detector 4 determines whether the cross-correlation function C exhibits a peak value ρ which is larger than a given detection threshold (for example, 5σ, where σ is the standard deviation of the correlation function). In that case, the watermark W(k) is said to be present. The peak detector also retrieves the position of said peak value, which corresponds to the amount of shift being applied to the watermark W(k), and thus represents the 10-bit payload d. However, this aspect is not relevant to the invention.

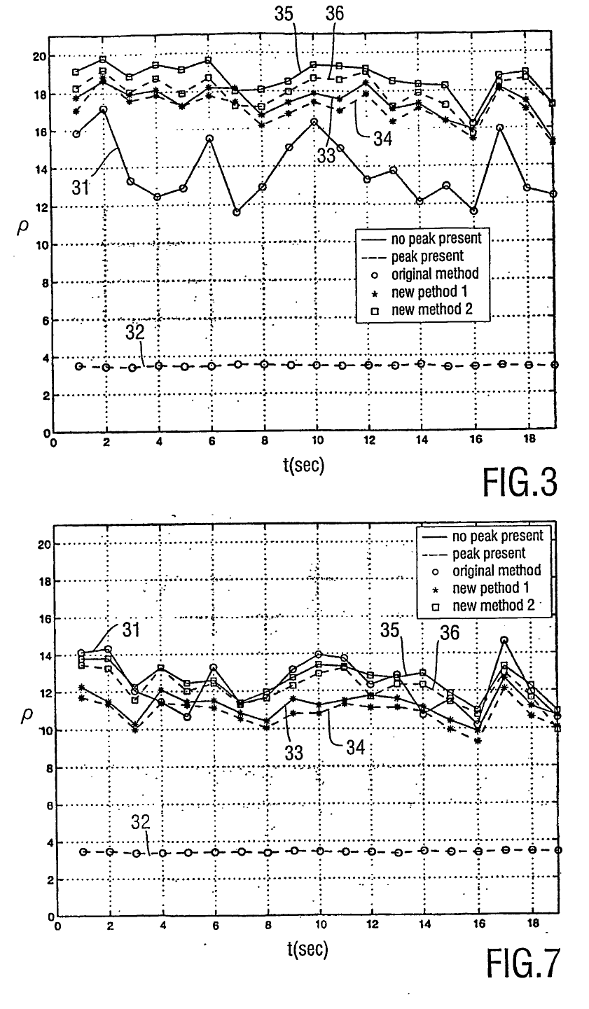

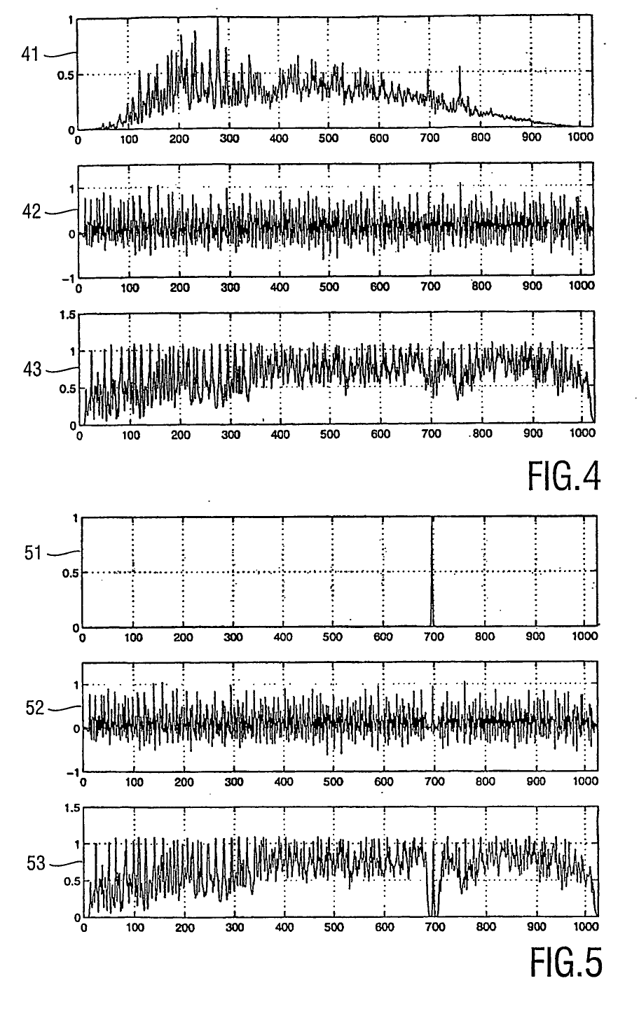

FIG. 3 shows graphs of correlation peak values ρ measured at 1 second intervals of an audio signal. A solid line 31 denotes the result for a regular piece of music. As can easily be seen, each peak value clearly exceeds the threshold value 5σ, i.e. the signal has an embedded watermark. A dashed line 32 denotes the peak values for the same piece of music, now being disturbed by a strong 15 kHz sine-wave. None of the peak values exceeds the threshold 5σ now. The detector will now erroneously determine that this signal has no embedded watermark. The problem is illustrated with reference to FIGS. 4 and 5. In FIG. 4, numeral 41 denotes a typical accumulated sequence Y(k) derived from a regular piece of music. In FIG. 5, numeral 51 denotes the corresponding sequence Y(k) derived from the same but disturbed piece of music. The 15 kHz tone dominates the signal such that the variations in magnitudes of the Fourier components in sequence 51, which carry the watermark information, shrink to insignificance compared to the variations in sequence 41.

A possible solution to overcome the problem is to ignore parts of the signals, for example: parts of video frames or parts of the audio spectrum, where the disturbing components are present. For example, the location of a logo in a video signal may be known in advance, so that the corresponding pixels can be ignored. Or, if an audio watermark detector is observing an FM radio station, the frequencies close to the carrier wave can be ignored. Ignoring parts of a signal can be seen as applying a more or less abrupt weighting function to the signal. However, the location of disturbing components is generally unknown. Some kind of mechanism is desired to adapt the weighting function to the signal.

To this end, the arrangement for detecting the watermark in accordance with the invention includes a pre-processing stage 2 between accumulation stage 1 and correlation stage 3 (cf. FIG. 2). The pre-processing stage includes a sub-segmentation unit 21, a weighting circuit 22, and a concatenation circuit 23.

The sub-segmentation unit 21 divides the accumulated sequence Y(k) into a plurality of possibly overlapping and windowed sub-sequences A(k). For audio signals, where the sequence Y(k) comprises 1024 signal samples, a sub-sequence length of 16 samples has been found to be a good choice.

The weighting circuit 22 subjects each individual sub-sequence to a weighting function. The weighting function is chosen to be such that the distribution of the signal samples over the whole sequence is substantially flat while the original variations of signal samples within each sub-sequence are retained. The expression “substantially flat” may mean, for example, that the mean value of the signal samples of a sub-sequences is the same for all the sub-sequences.

In one embodiment, this is achieved by normalizing the magnitudes of each sub-sequence in the frequency domain. To this end, the weighting circuit performs the following operation:
B(k)=F⁻¹(P(F(A(k))) (1)
where F(.) denotes the Fourier transform, P(.) denotes the phase only operation as defined above, and F⁻¹(.) denotes the inverse Fourier transform.

In another embodiment, the weighting is carried out by the following scaling operation:

$${B}_{k} = \frac{{A}_{k}}{max ( \vert {A}_{k} \vert )} \qquad ( 2 )$$

where Aₖ and Bₖ denote samples of the original sub-sequence A(k) and the weighted sub-sequence B(k), respectively, and |Aₖ| is the largest absolute value of the signal samples of sub-sequence A(k).

The weighted sub-sequences B(k) are subsequently concatenated by the concatenation circuit 23, to obtain the pre-processed sequence Z(k). If the sub-sequences overlap each other, suitable windows (e.g. Hanning windows) are preferably applied on B(k). It is the pre-processed sequence Z(k) that is input to the correlation stage 2.

FIG. 6 shows diagrams to schematically illustrate the pre-processing operation. Reference numeral 61 denotes an accumulated sequence Y(k) being divided into sub-sequences A(k). Reference numeral 62 denotes the sequence Z(k) being obtained by concatenating weighted sub-sequences B(k). As has been attempted to show, each sub-sequence A(k) has been weighted. The same weighting factor has been applied to all signal samples of a sub-sequence, but different weighting factors have been applied to different sub-sequences. The result is a flatter distribution of signal samples while the variations in signal samples is locally retained.

FIGS. 4 and 5 illustrate the effect of the pre-processing stage 2 for a particular piece of music in practice. As already mentioned above, numeral 41 in FIG. 4 denotes an accumulated sequence Y(k) derived from a regular piece of music. Numeral 51 in FIG. 5 denotes the accumulated sequence Y(k) derived from the same piece of music being disturbed by a strong 15 kHz tone. The sequences comprise 1024 accumulated signal samples. Reference numerals 42 and 52 denote the corresponding weighted sequences Z(k) obtained by normalizing the magnitudes of each sub-sequence in the frequency domain as defined by equation (1). Reference numerals 43 and 53 denote the corresponding weighted sequences Z(k) obtained by scaling as defined by equation (2). For both pieces of music, but particularly for the disturbed piece of music, the diagrams indicate that a significantly larger correlation peak can be expected to be detected by the correlation stage.

The improvement achieved with the watermark detection method according to the invention is shown in FIG. 3. In this Figure, solid lines refer to the regular piece of music and dashed lines refer to the disturbed piece of music. Solid line 31 and dashed line 32 have already been discussed before. Solid lines 33 and 35 show the performance of the weighting operation in accordance with equation (1). Dashed lines 34 and 36 show the performance of the weighting operation in accordance with equation (2). As can easily be seen, all the peak correlation values lie above the threshold 5σ used by the peak detector 4. For completeness, FIG. 7 shows the same graphs with identical legends and reference numerals for the same piece of music but now being mp3 encoded and subsequently decoded.

In the embodiments described above, the watermark is represented by slight modifications of the magnitudes of Fourier coefficients, i.e. in the frequency domain. However, it will be appreciated that the invention is equally applicable to detection of a watermark being embedded in the temporal or spatial (video) domain.

A watermark detection method is disclosed which is based on computing the cross-correlation between a suspect signal and a watermark. In order to be more robust against prolonged dominant signal components that adversely affect the correlation, the sequence of signal samples (61) to be correlated with the watermark is divided into sub-sequences (A(k)). The sub-sequences are processed, by a weighting function, to obtain modified sub-sequences (B(k)) that individually exhibit the original signal variations, but collectively (62) exhibit a flatter distribution of sample values. Dominant peaks in the signal are thereby substantially reduced.

1. A method of detecting a watermark in a signal, the method comprising the steps of computing a correlation between a sequence of signal samples and a predetermined watermark, and detecting whether said correlation exceeds a given threshold, characterized in that the method includes pre-processing of said sequence of signal samples, said pre-processing comprising the steps of:
dividing the sequence of signal samples into sub-sequences;
subjecting all signal samples of a sub-sequence to the same weighting, and varying said weighting from sub-sequence to sub-sequence to obtain a substantially flat distribution of signal samples over the sequence; and
concatenating the weighted sub-sequences to obtain the pre-processed sequence of signal samples.

2. The method as claimed in claim 1, further including the step of accumulating a plurality of sequences of signal samples prior to correlation, characterized in that said pre-processing is applied to said accumulated sequences.

3. The method as claimed in claim 1, wherein said step of dividing the sequence of signal samples into sub-sequences comprises dividing into overlapping sub-sequences.

4. The method as claimed in claim 3, wherein said overlap is 50%.

5. The method as claimed in claim 3, wherein said step of dividing into overlapping sub-sequences includes applying a window function to said overlapping sub-sequences.

6. The method as claimed in claim 1, wherein said step of weighting comprises Fourier transforming the sub-sequence of signal samples, normalizing the magnitudes of the Fourier coefficients, and back-transforming the normalized coefficients.

7. The method as claimed in claim 1, wherein said step of weighting comprises dividing all signal samples of a sub-sequence by the largest signal sample of said sub-sequence.

8. An arrangement for detecting a watermark in a signal, the arrangement comprising computing means for computing a correlation between a sequence of signal samples and a predetermined watermark, and thresholding means for detecting whether said correlation exceeds a given threshold, characterized in that the arrangement includes pre-processing means for pre-processing said sequence of signal samples, said pre-processing means comprising:
dividing means for dividing the sequence of signal samples into sub-sequences;
weighting means for subjecting all signal samples of a sub-sequence to the same weighting, and varying said weighting from sub-sequence to sub-sequence to obtain a substantially flat distribution of signal samples over the sequence; and
concatenating means for concatenating the weighted sub-sequences to obtain the pre-processed sequence of signal samples.

9. A computer program product arranged to cause a computer executing said computer program to carry out the method as claimed in claim 1.
